(19) United States
(12) Patent Application Publication
(10) Pub. No.: US 2019/0002244 A1
(43) Pub. Date: Jan. 3, 2019

(54) SELF CLEANING ELEVATOR

(71) Applicant: Otis Elevator Company, Farmington, CT (US)

(72) Inventor: Laurent Coldre, La neuville sur essonce (FR)

(21) Appl. No.: 15/748,941

(22) PCT Filed: Jul. 31, 2015
(86) PCT No.: PCT/IB2015/001533

§ 371 Date: Jan. 30, 2018

(51) Int. Cl. B66B 11/02

(52) U.S. Cl. CPC B66B 11/024; B66B 11/0226

(57) ABSTRACT

A method and system to provide a self-cleaning elevator car (12) is disclosed. The elevator car (12) includes at least one hydrophobic interior surface (16) and an air intake system to provide a laminar airflow (36) between an at least one inlet (30) and an at least one outlet (32).

### BACKGROUND

The subject matter disclosed herein relates to elevator cars, and to a system and a method for self-cleaning an elevator car.

Typically, interior surfaces within an elevator car are designed for occupant contact to allow for user control, support, and comfort. During the course of elevator operation, elevator car interior surfaces and the elevator car volume may become contaminated. For example, the elevator car volume and elevator car interior surfaces may contain odors, bacteria, viruses, excess carbon dioxide, dirt, etc.

In order to remove such contaminants, elevator cars are often subjected to deep cleanings. Deep cleaning of elevators often requires substantial elevator down time, the replacement of elevator interior surfaces, harmful chemicals, etc. A system and method that can provide a self-cleaning elevator is desired.

### BRIEF SUMMARY

According to an embodiment, an elevator car includes at least one hydrophobic interior surface, and an air intake system to provide a laminar airflow between an at least one inlet and an at least one outlet.

In addition to one or more of the features described above, or as an alternative, further embodiments could include that the at least one hydrophobic interior surface is disposed between the at least one inlet and the at least one outlet.

In addition to one or more of the features described above, or as an alternative, further embodiments could include that the at least one inlet is disposed at an upper extent of the elevator car.

In addition to one or more of the features described above, or as an alternative, further embodiments could include that the at least one outlet is disposed at a lateral extent of the elevator car.

In addition to one or more of the features described above, or as an alternative, further embodiments could include that the at least one hydrophobic interior surface is a laser treated surface.

In addition to one or more of the features described above, or as an alternative, further embodiments could include that the air intake system provides a positive airflow.

In addition to one or more of the features described above, or as an alternative, further embodiments could include that the air intake system can direct the laminar airflow.

According to an embodiment, a method to clean an elevator car includes providing at least one hydrophobic interior surface, providing a laminar airflow between an at least one inlet and an at least one outlet via an air intake system, and removing a contaminant from the elevator car via the laminar airflow.

In addition to one or more of the features described above, or as an alternative, further embodiments of the method could include that the at least one hydrophobic interior surface is disposed between the at least one inlet and the at least one outlet.

In addition to one or more of the features described above, or as an alternative, further embodiments of the method could include that the at least one inlet is disposed at an upper extent of the elevator car.

In addition to one or more of the features described above, or as an alternative, further embodiments of the method could include that the at least one outlet is disposed at a lateral extent of the elevator car.

In addition to one or more of the features described above, or as an alternative, further embodiments of the method could include that the at least one hydrophobic interior surface is a laser treated surface.

In addition to one or more of the features described above, or as an alternative, further embodiments of the method could include providing a positive airflow via the air intake system.

In addition to one or more of the features described above, or as an alternative, further embodiments of the method could include directing the laminar airflow via the air intake system.

The technical function of the embodiments described above includes at least one hydrophobic interior surface, and an air intake system to provide a laminar airflow between an at least one inlet and an at least one outlet.

Other aspects, features, and techniques of the embodiments will become more apparent from the following description taken in conjunction with the drawings.

### BRIEF DESCRIPTION OF THE DRAWINGS

The subject matter is particularly pointed out and distinctly claimed in the claims at the conclusion of the specification. The foregoing and other features, and advantages of the embodiments are apparent from the following detailed description taken in conjunction with the accompanying drawings in which like elements are numbered alike in the FIGURES:

FIG. 1A illustrates a schematic view of an embodiment of an elevator car traveling in an upward direction;

FIG. 1B illustrates a schematic view of an embodiment of an elevator car traveling in a downward direction; and

FIG. 2 is a flowchart illustrating a method to self-clean an elevator car.

### DETAILED DESCRIPTION

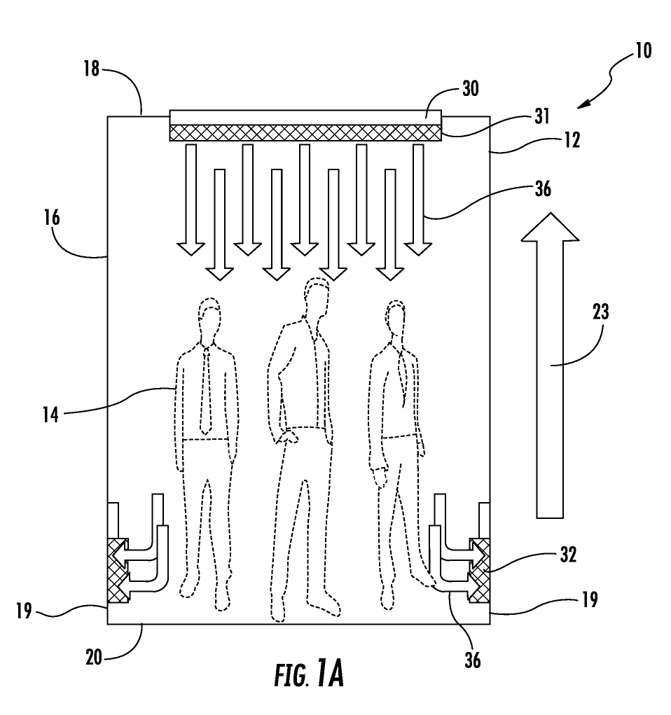

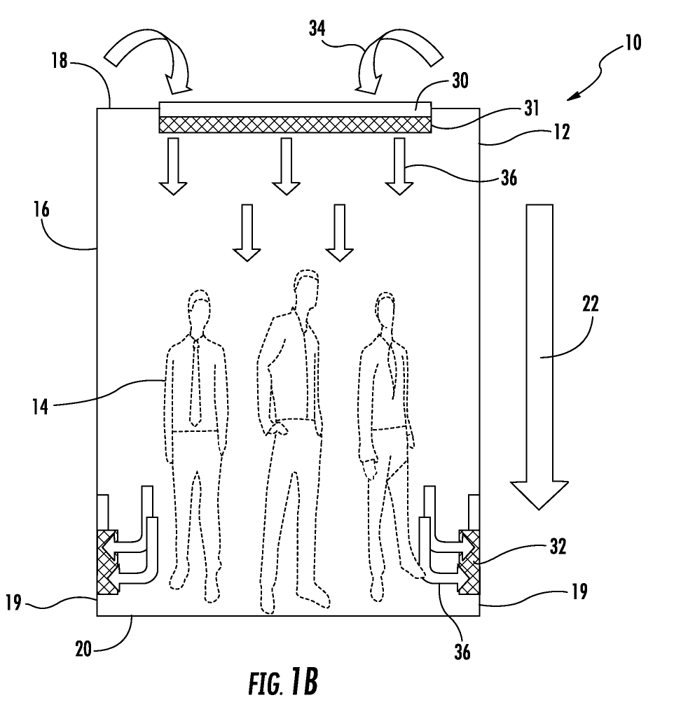

Referring to FIG. 1A, an illustrated embodiment of a self-cleaning elevator 10 is shown. In the illustrated embodiment, the self-cleaning elevator 10 includes an elevator car 12 with interior surfaces 16, an inlet 30, and an outlet 32. In the illustrated embodiment, the self-cleaning elevator 10 can provide directed airflow 36 to remove airborne contaminants and surface containments from the interior surfaces 16.

In the illustrated embodiment, the elevator car 12 includes interior surfaces 16, an upper extent 18, lateral extents 19, and a lower extent 20. The elevator car 12 can transport occupants 14 between floors in an upward direction 23, and a downward direction 24 (as shown in FIG. 1B). During operation, the occupants 14 can interact with the elevator car 12 at designated touch points, such as hand rails, control panels, etc. In certain embodiments, such contacted interior surfaces can be exposed to contamination or dirt. During operation the occupants 14 can also interact with other interior surfaces of the elevator car 12 not designed for occupant interaction, such as the ceiling. Further, the elevator car 12 can become contaminated from general use and environmental exposure.

In the illustrated embodiment, the interior surfaces 16 of the elevator car 12 are hydrophobic interior surfaces. Advantageously, hydrophobic interior surfaces 16 can resist and repel most contaminants, while allowing an airflow 36 to remove any resident contaminants from the surface 16. In the illustrated embodiment, such interior surfaces 16 are disposed generally between the inlet 30 and the outlets 32 to be utilized with the airflow system of the elevator car 12 to provide a self-cleaning elevator car 10. In certain embodiments, the interior surfaces 16 can be laser treated interior surfaces that resist the attachment and absorption of contaminants such as chemicals, dirt, bacteria, and viruses. In certain embodiments, the interior surfaces 16 are treated to provide a microscopically smooth surface to prevent and limit attachment of foreign objects. Advantageously, such interior surfaces 16 can require less deep cleaning, minimizing the use of water and chemicals. In certain embodiments, such treated interior surfaces 16 are scratch resistant interior surfaces.

In the illustrated embodiment, the interior surfaces 16 define the volume of the elevator car 12. In certain embodiments, the interior surfaces 16 can prevent or limit the contamination resident in the volume of the elevator car 12 by preventing contaminants from remaining resident within the elevator car 12 and allowing removal of contaminants via the airflow 36.

In the illustrated embodiment, an airflow system of the self-cleaning elevator 10 can provide airflow 36 to remove contaminants from the volume and the interior surfaces 16 of the elevator car 12. The airflow system can include an inlet 30, and at least one outlet 32.

In the illustrated embodiment, an inlet 30 is disposed at an upper extent 18 of the elevator car 12. In certain embodiments, the inlet 30 includes a filtration device 31. In certain embodiments, the inlet 30 includes a laminar flow device to create laminar airflow 36. In certain embodiments, the inlet 30 can direct the airflow 36 within the elevator car 12. The inlet 30 can include a fan or other suitable device to provide airflow 36 within the elevator car 12. In certain embodiments, the inlet 30 can provide airflow 36 via passive means, such as the motion of the elevator car 12 within the elevator shaft. In certain embodiments, the inlet 30 can be selectively opened or closed as needed to prevent unwanted airflow.

In the illustrated embodiment, the outlets 32 are disposed near the lower extent 20 of the elevator car 12. In certain embodiments, the outlets 32 are disposed near the lateral extents of the elevator car 12. Additionally, the outlets 32 may be disposed near the lower extents of the elevator car 12 to allow for a greater pressure differential between the outlets 32 and the inlet 30, and further to allow the airflow 36 to interact with a greater portion of the elevator car 12. In the illustrated embodiment, the elevator car 12 includes a plurality of outlets 32 to receive the airflow 36 from the inlet 30. In certain embodiments, the outlets 32 can be selectively opened or closed as needed to prevent unwanted airflow.

In the illustrated embodiment, the airflow 36 moves from the inlet 30 to the outlets 32 due to a pressure differential between the inlet 30 and the outlets 32. In the illustrated embodiment, the inlet 30 experiences a greater pressure than the outlets 32, facilitating the airflow 36 between the inlet 30 and the outlets 32. As the airflow 36 moves through the elevator car 12, contaminants contained within the elevator car 12 volume and the interior surfaces 16 of the elevator car 12 are removed. Advantageously, contaminants are easily removed from within the elevator car 12 due to the treatment of the interior surfaces 16 described above. In the illustrated embodiment, the airflow 36 speed is selected to provide occupant comfort while effectively removing contaminants from within elevator car 12. In certain embodiments, the airflow 36 can be provided to an unoccupied elevator car 12 to clean the unoccupied elevator car 12 as desired. In certain embodiments, the airflow 36 can be scheduled at desired times via active means or by passive means by scheduling the elevator car 12 to travel within the elevator shaft.

In certain embodiments, the airflow 36 can be directed or otherwise localized via the inlet 30 and the outlets 32. The airflow 36 characteristics can be adjusted by varying the location, size, and other properties of the inlet 30 and the outlet 32. In certain embodiments, the inlet 30 and the outlets 32 can utilize an active airflow solution, while in other embodiments, the airflow 36 is passive from the movement 23 of the elevator car 12. In certain embodiments, the movement of the elevator car 12 and inlet 30 are controlled to limit or control the airflow 36 therein.

Referring to FIG. 1B, the self-cleaning elevator car 10 can travel in a downward direction 22. During downward travel, the inlet 30 can draw in supplemental airflow 34 to ensure a minimum amount of airflow 36 regardless of direction. In the illustrated embodiment, the airflow 36 is supplemented by supplemental airflow 34 to provide occupant comfort while effectively removing contaminants from within elevator car 12 while traveling in a downward direction 22 to ensure a positive airflow from the inlet 30 to the outlets 32 in all conditions. In certain embodiments, the supplemental airflow 34 can be provided by operating a fan within the inlet 30 at a suitable speed to ensure a minimum amount of airflow 36 regardless of direction, opening additional vents within the inlet 30 to ensure a minimum amount of airflow 36 regardless of direction, otherwise directing additional air into the inlet 30 to ensure a minimum amount of airflow 36 regardless of direction.

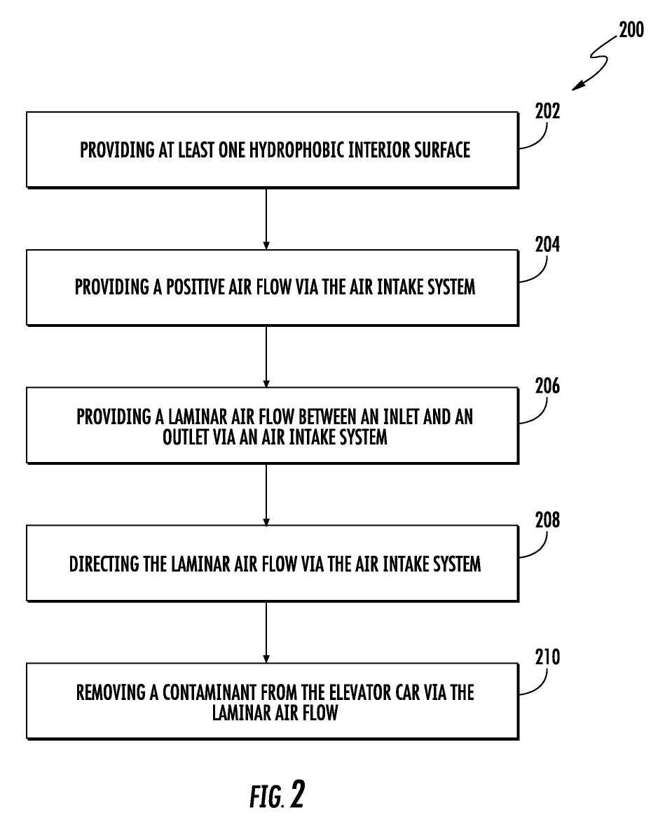

Referring to FIG. 2, a method 200 to self-clean an elevator is shown. In operation 202, an elevator car with at least one hydrophobic interior surface is provided. Advantageously, hydrophobic interior surfaces can resist and repel most contaminants, while allowing an airflow to remove any resident contaminants from the surface. In certain embodiments, the interior surfaces can be laser treated interior surfaces that resist the attachment and absorption of contaminants such as chemicals, dirt, bacteria, and viruses. In certain embodiments, the interior surfaces are treated to provide a microscopically smooth surface to prevent and limit attachment of foreign objects.

In operation 204, the elevator can provide a positive airflow via the air intake system during both downward and upward travel. During downward travel, the inlet can draw in supplemental airflow to ensure a minimum amount of airflow regardless of direction.

In operation 206, the self-cleaning elevator can provide a laminar airflow between an inlet and an outlet via an air intake system. In certain embodiments, the inlet includes a laminar flow device to create laminar airflow.

In operation 208, the inlet can direct the laminar airflow via the air intake system. In certain embodiments, the inlet can direct the airflow within the elevator car.

In operation 210, the laminar airflow can remove a contaminant from the elevator car. In the illustrated embodiment, the airflow moves from the inlet to the outlets. As the airflow moves through the elevator car, contaminants contained within the elevator car volume and the interior surfaces of the elevator car are removed. Advantageously, contaminants are easily removed from within the elevator car due to the treatment of the surface described above.

The terminology used herein is for the purpose of describing particular embodiments only and is not intended to be limiting of the embodiments. While the description of the present embodiments has been presented for purposes of illustration and description, it is not intended to be exhaustive or limited to the embodiments in the form disclosed. Many modifications, variations, alterations, substitutions or equivalent arrangement not hereto described will be apparent to those of ordinary skill in the art without departing from the scope and spirit of the embodiments. Additionally, while various embodiments have been described, it is to be understood that aspects may include only some of the described embodiments. Accordingly, the embodiments are not to be seen as limited by the foregoing description, but are only limited by the scope of the appended claims.

1. An elevator car comprising:
at least one hydrophobic interior surface; and
an air intake system to provide a laminar airflow between an at least one inlet and an at least one outlet.

2. The elevator car of claim 1, wherein the at least one hydrophobic interior surface is disposed between the at least one inlet and the at least one outlet.

3. The elevator car of claim 1, wherein the at least one inlet is disposed at an upper extent of the elevator car.

4. The elevator car of claim 1, wherein the at least one outlet is disposed at a lateral extent of the elevator car.

5. The elevator car of claim 1, wherein the at least one hydrophobic interior surface is a laser treated surface.

6. The elevator car of claim 1, wherein the air intake system provides a positive airflow.

7. The elevator car of claim 1, wherein the air intake system can direct the laminar airflow.

8. A method to clean an elevator car, comprising:
providing at least one hydrophobic interior surface;
providing a laminar airflow between an at least one inlet and an at least one outlet via an air intake system; and
removing a contaminant from the elevator car via the laminar airflow.

9. The method of claim 8, wherein the at least one hydrophobic interior surface is disposed between the at least one inlet and the at least one outlet.

10. The method of claim 8, wherein the at least one inlet is disposed at an upper extent of the elevator car.

11. The method of claim 8, wherein the at least one outlet is disposed at a lateral extent of the elevator car.

12. The method of claim 8, wherein the at least one hydrophobic interior surface is a laser treated surface.

13. The method of claim 8, further comprising providing a positive airflow via the air intake system.

14. The method of claim 8, further comprising directing the laminar airflow via the air intake system.
